(19) United States
(12) Patent Application Publication
(10) Pub. No.: US 2005/0238092 A1
(43) Pub. Date: Oct. 27, 2005

(54) Method and system for error estimation for adaptive equalization in communication systems

(76) Inventor: Devin K. Ng, Mission Viejo, CA (US)

Correspondence Address: KLEIN, O'NEILL & SINGH, 2 PARK PLAZA, SUITE 510, IRVINE, CA, 92614, US

(21) Appl. No.: 10/830,368

(22) Filed: Apr. 22, 2004

(51) Int. Cl. H04B 3/46

(52) U.S. Cl. 375/224

(57) ABSTRACT

A system and method for in a communication system is provided. The system includes logic for obtaining a symbol width by examining transition bit values for at least three symbols, wherein if the transition bit values are of same polarity as a central data symbol then the symbol width is too wide, or if the transition bits are of opposite polarity, then the symbol is too narrow. The method includes, determining whether received symbols are too wide or narrow with respect to a clock signal by examining transition bit values for at least three symbols, wherein if the transition bit values are of same polarity as a central data symbol then the symbol width is too wide, or if the transition bits are of opposite polarity, then the symbol is too narrow; and adjusting equalization coefficient values if the symbols are wide or narrow.

### BACKGROUND OF THE INVENTION

1. Field of the Invention

The present invention relates to high-speed communication links, and more particularly, to error estimation using adaptive equalization.

2. Background

Computing devices commonly use high-speed links for communication. Such links comply with various standards, including fibre channel standards, incorporated herein by reference, in its entirety. Often these devices are a part of a network, including storage area network.

FIG. 1A shows an example of a host computing system 100 connected to fiber channel fabric and fiber channel devices. Host system (includes computers, file server systems or similar devices) 100 with controller 100B and ports 100C and 100D is coupled to fiber channel fabric 100E. In turn, fiber channel fabric 100E is coupled to fiber channel devices 100F, 100G and 100H. The fiber channel devices 100F, 100G and 100H may be stand-alone disk storage systems or multiple disk storage systems (e.g. a RAID system).

Host system 100 may use a high-speed link for transferring data; for example, a 10 gigabit per second (“Gbs”) link to send data to fiber channel devices 100F, 100G and 100H, respectively.

Various components used in modern day networks employ host bus adapters, switches, hubs and other modules to move data. These modules have serial/de-serialzers (SERDES) for converting serial data into a format that can be processed by the respective modules (often from 10 bit to 8 bit and vice-versa).

High-speed communication links witness losses during transmission. High-speed communication links use channel equalization to compensate for losses in the channel. Typical communication channels have low pass frequency characteristics, i.e. high frequency components of the signal are attenuated more than low frequency components.

FIG. 1B shows an example of a communication link 100A. A transmitting link 101 communicates with channel 103. The transmit signal 102 is illustrated in FIG. 1C and the channel signal 104 from channel 103 is shown in FIG. 1D.

As shown in FIG. 1D, the output from channel 103 is degraded. The degradation in signal 104 manifests itself as deterministic jitter due to inter-symbol interference (“ISI”) and reduction in amplitude. Amplitude reduction can be handled by using a limiting amplifier, however jitter reduction requires complex equalization techniques.

One conventional approach regarding channel equalization is to use an equalization filter with fixed coefficients. This approach is shown in the schematic of FIG. 1E, where equalizer (“EQ”) 106 is used and the output 107 of EQ 106 is graphically illustrated in FIG. 1F, where jitter is removed in signal 107 and amplitude is restored.

Using EQ filter 106 has disadvantages, since it requires prior information about the channel that is being equalized (103) for optimizing EQ filter 106 outputs. Any deviation of the channel being equalized from its assumed characteristics may result in degradation, rather than improvement.

One solution to this problem is to use an adaptive filter by making the coefficients adaptable. Hence, when channel characteristics are other than those of the original channel, i.e., time varying channel characteristics, or different physical channels, the coefficients of the filter adapt to some optimum value.

One method used for adapting filter coefficients is by using the least mean squared (“LMS”) algorithm. The LMS algorithm uses the error value produced at a receiver's input. This error value is typically defined as the difference between the actual received data value and an ideal data value. The error value is correlated with the internal states of the filter to update/adjust the coefficient values.

In high-speed communication links, obtaining this error value is difficult due to limited bandwidth of today's transistor technology. Obtaining the exact error value would require analog subtraction at a very high speed. For an optimal digital solution an analog/digital (A/D) converter will be required, which is difficult to implement at high baud rates. Also, to avoid incorrect sampling of the error signal without using complex comparators or A/D converters, a linear front end will be needed. This precludes using a limiting amplifier before the decision circuit.

FIG. 3 shows an equalized system with an adaptive equalizer 301 that sends a signal to a clock and data recovery module (“CDR”) 302, which is described below with respect to FIG. 2A. Logic (or circuit) 306 receives symbol 303 and retrieved signal 304A, and then generates error signal 305. Logic 306 is shown as an analog subtractor and will be difficult to implement in high bandwidth systems. A complex A/D converter (306A) will be needed for a digital solution.

Another problem faced by high-speed communication links is clock and data recovery from incoming stream of data symbols. This is achieved by using a CDR module (FIG. 3 and 2A). As shown in FIG. 2A, CDR 302 uses a phase locked loop (“PLL”) 201 for recovering clock and data signals. PLL 201 includes a voltage-controlled oscillator (“VCO”) 207, which provides the recovered clock 207A (similar to 304A) based on a tuning voltage.

A phase detector 204 compares the phase of the recovered clock relative to the phase of incoming data 202. The resulting phase error is amplified by phase detector 204 and sent to charge pump 205 and the charge pump 205 output is then filtered by loop filter 206. The output from loop filter 206 is then fed into VCO 207, which in turn adjusts the phase of the recovered clock. Hence, the recovered clock approaches phase alignment with the incoming data. A D-Flip-Flop 203 is used to generate retrieved data 203 based on input 203 and 207A for binary modulation (“NRZ”).

One type of phase detector 204 that is well suited for high-speed communication applications is known as the “Alexander” or “bang-bang” phase detector. This phase detector samples twice per baud, one at the middle of the symbol and one at the edge of the symbol. Based on the combination of data and transition samples (208 and 209), as shown in FIG. 2B, the clock is either advanced or retarded in phase. D0 is the value of the first data bit, T0 is the value of the transition bit, and D1 is the value of the data bit after D0. FIG. 2C shows a truth table for generating an UP and DOWN signal based on the value of D0, T0 and T1.

FIG. 2D shows the logic for an Alexander phase detector 216. Receive signal 217 is fed into D-Flops 210 and 211, where 210 generates data sample Dn and 211 generates transition sample, Tn. Latch 212 aligns the Dn and T signal samples and D-Flop 213 saves the previous data sample (Dn-1). Thereafter, signals 214 (Down) and 215 (Up) are generated based on the truth table values shown in FIG. 2C.

To advance or retard the phase of the clock, an UP/Down (DN) signal, as shown in FIG. 2D is sent to a charge pump 205, which sends a signal to loop filter 206. FIG. 2E shows a timing diagram for FIG. 2D signals.

FIG. 4 shows a single tap decision feedback equalizer circuit 400 for using the LMS algorithm to adapt coefficients. FIG. 5 shows a single tap transversal filter 500 to adapt coefficients using the LMS algorithm. Both circuits 400 and 500 can be used in 301 of FIG. 3.

Conventional systems are inaccurate and complex in correcting channel-induced errors. Therefore, there is a need for a method and system to efficiently perform error estimation.

### SUMMARY OF THE INVENTION

In one aspect of the present invention, error estimation is performed without using complex components like analog to digital converters.

In one aspect, a circuit and system for determining whether symbols received in a communication system are too wide or narrow with respect to a clock signal is provided. The circuit and/or system includes logic for obtaining a symbol width by examining transition bit values for at least three symbols, wherein if the transition bit values are of same polarity as a central data symbol then the symbol width is too wide, or if the transition bits are of opposite polarity, then the symbol is too narrow.

In yet another aspect, a method for error estimation in a communication system is provided. The method includes, determining whether received symbols are too wide or narrow with respect to a clock signal by examining transition bit values for at least three symbols, wherein if the transition bit values are of same polarity as a central data symbol then the symbol width is too wide, or if the transition bits are of opposite polarity, then the symbol is too narrow; and adjusting equalization coefficient values if the symbols are wide or narrow.

This brief summary has been provided so that the nature of the invention may be understood quickly. A more complete understanding of the invention can be obtained by reference to the following detailed description of the preferred embodiments thereof in connection with the attached drawings.

### BRIEF DESCRIPTION OF THE DRAWINGS

The foregoing features and other features of the present invention will now be described with reference to the drawings of a preferred embodiment. In the drawings, the same components have the same reference numerals. The illustrated embodiment is intended to illustrate, but not to limit the invention. The drawings include the following Figures:

FIG. 1A shows an example of a host computing system coupled to various devices;

FIGS. 1B shows a prior art example of a communication system;

FIG. 1C graphically illustrates the output from a prior art transmitter;

FIG. 1D shows jitter in a prior art system;

FIG. 1E shows a prior art system with an equalizer;

FIG. 1F shows a graphical illustration of the equalizer output in FIG. 1E;

FIG. 2A shows a prior art clock and data recovery module;

FIGS. 2B-2E show prior art use of an Alexander Phase detector;

FIG. 3 shows an example of a prior art system using an adaptive equalizer;

FIG. 4 shows an example of a prior art decision feedback equalizer circuit;

FIG. 5 shows an example of a prior art transversal filter;

FIG. 6A shows a graphical example of a timing diagram, according to one aspect of the present invention;

FIG. 6B shows an example of a truth table for FIG. 6A data and timing bit values;

FIG. 7A shows an example of a circuit that can be used according to one aspect of the present invention;

FIG. 7B shows an example of a timing diagram for error and phase detection, according to one aspect of the present invention;

FIG. 7C shows a schematic for using error and phase detection, according to one aspect of the present invention;

FIG. 7D shows a schematic for using error and phase detection in a transverse filter, according to one aspect of the present invention;

FIG. 8A shows a schematic for using an adaptive equalizer, according to one aspect of the present invention;

FIG. 8B shows a graphical illustration of an adaptive equalizer output, according to one aspect of the present invention; and

FIG. 9 shows a flow diagram for error estimation, according to one aspect of the present invention.

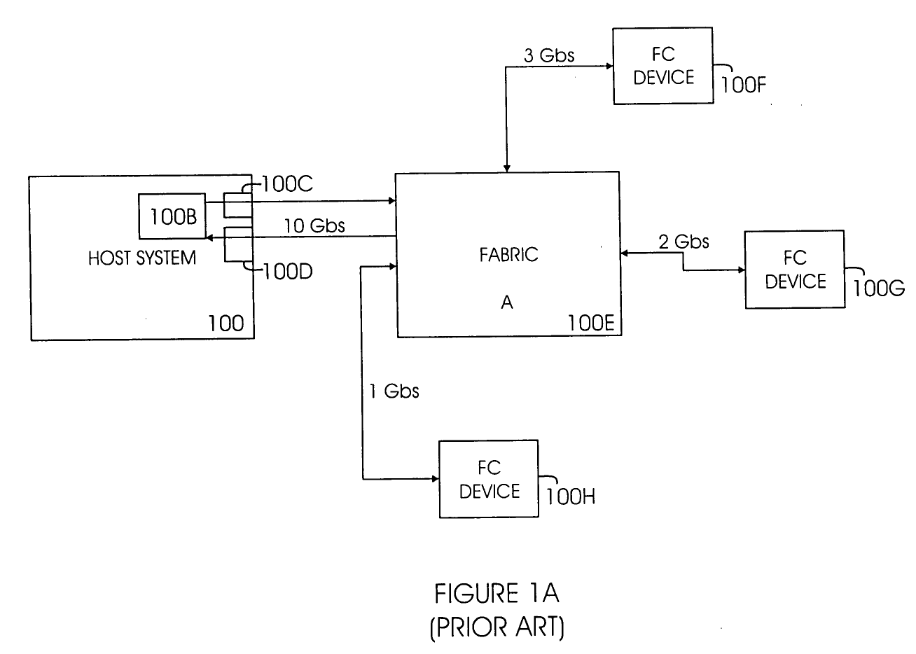

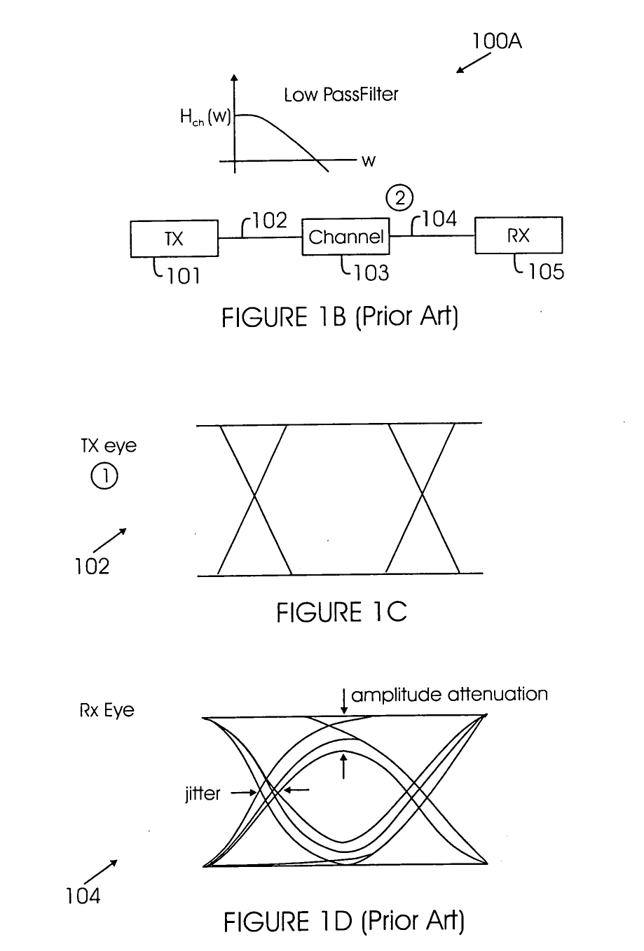

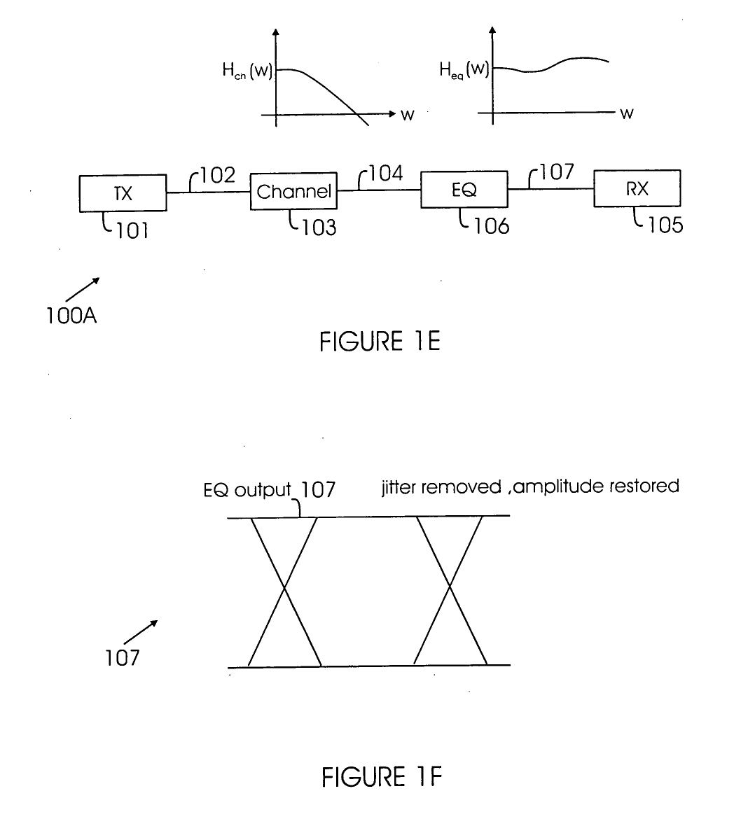

### DETAILED DESCRIPTION OF THE PREFERRED EMBODIMENTS

In one aspect of the present invention, successive transition samples are examined to determine whether received symbols are too wide or narrow. Symbols, which are too wide, imply over-equalization and narrow symbols imply under-equalization, assuming that the channel has low pass characteristic. The width of the symbols is obtained by examining the value of the transition bits when two consecutive data transition occur. This is achieved by examining three consecutive symbols. If both transition bits are of the same polarity as the central data symbol, the symbol is said to be too wide. Alternatively, if both transition bits are of opposite polarity of the central bit, the symbol is too narrow.

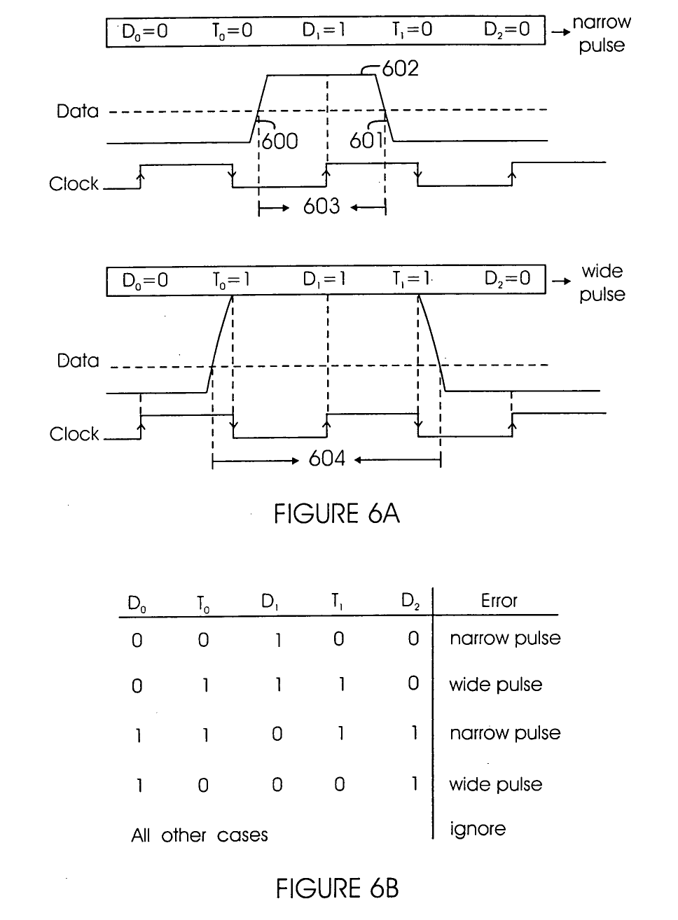

FIG. 6A provides a graphical illustration by the showing a transition diagram, according to one aspect of the present invention. In FIG. 6A, D0, T0, D1, T1 and D2 are data and transition bits for two consecutive data transitions. The first transition is shown as 600 and the second transition is shown as 601. The middle data period 602 is either too wide or narrow depending upon whether it is over or under-equalized. For example, pulse 603 is narrow, while pulse 604 is wide.

FIG. 6B shows a truth table with respect to narrow and wide pulses based on the data and timing bit values, as shown graphically in FIG. 6A.

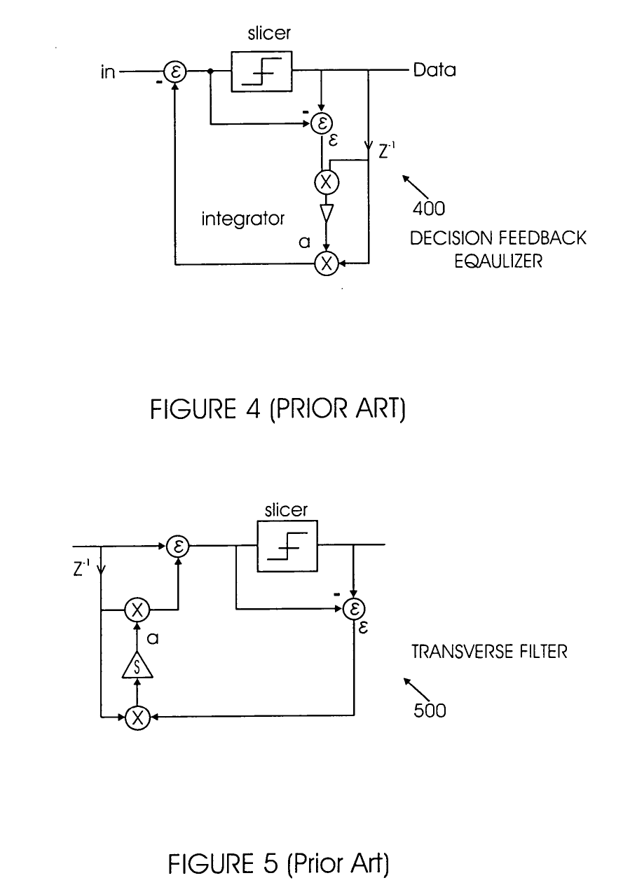

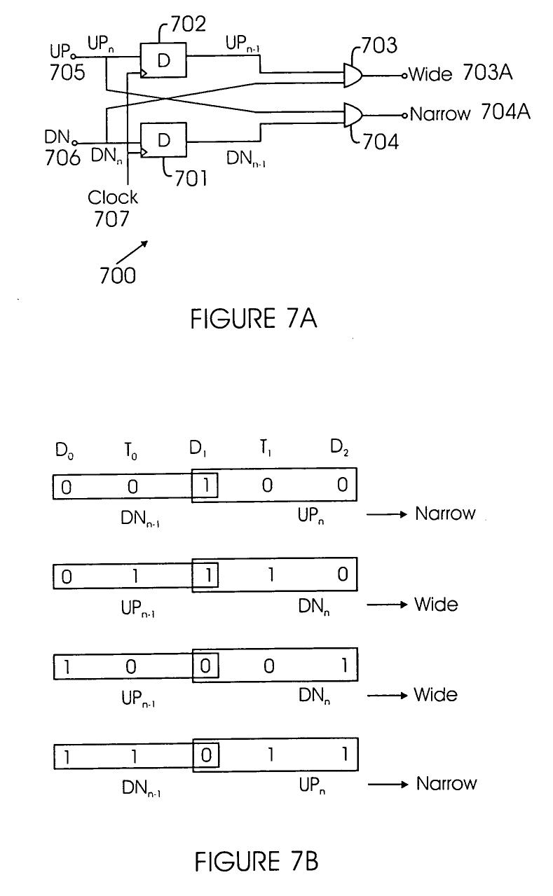

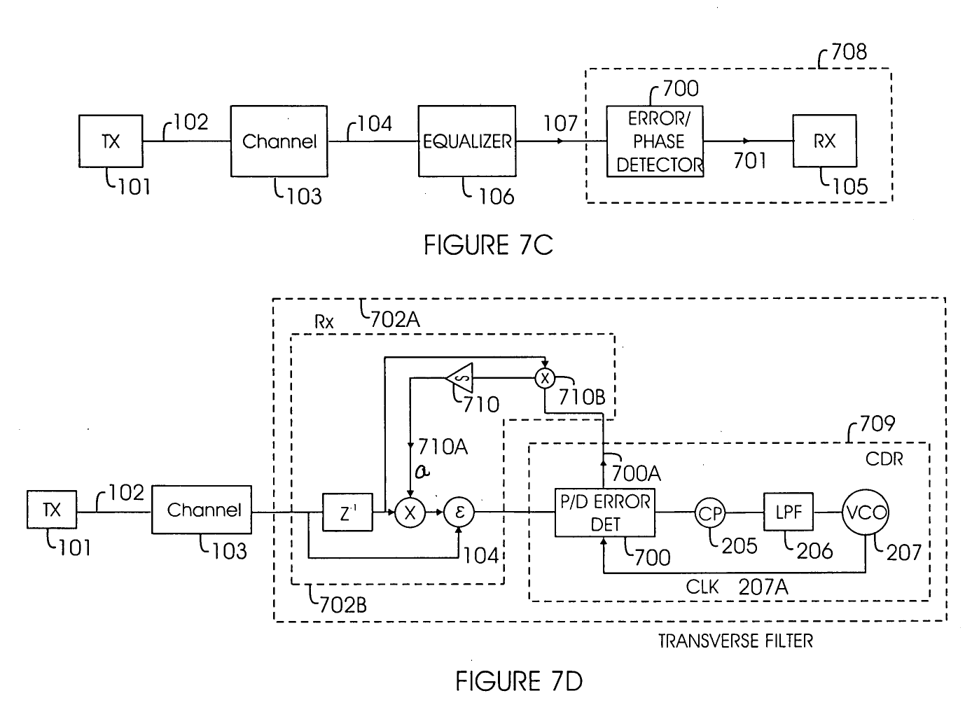

The width of the symbol is de-correlated from the value of the symbol, in order to extract the sign of an error signal for use in a signed error LMS algorithm (with respect to FIGS. 4 and 5 circuit diagrams). Wide symbols with positive data imply a positive error sign, while negative data imply a negative error sign. Narrow symbols with negative data imply a positive error sign and narrow symbols with positive data imply a negative error sign. The sign of the error is then correlated with the gradient of the input and integrated to update the coefficients as in a standard signed-error LMS algorithm. This is achieved by adding logic to Alexander Phase detector 216. FIG. 7A shows logic 700 that combines error and phase detection, according to one aspect of the present invention.

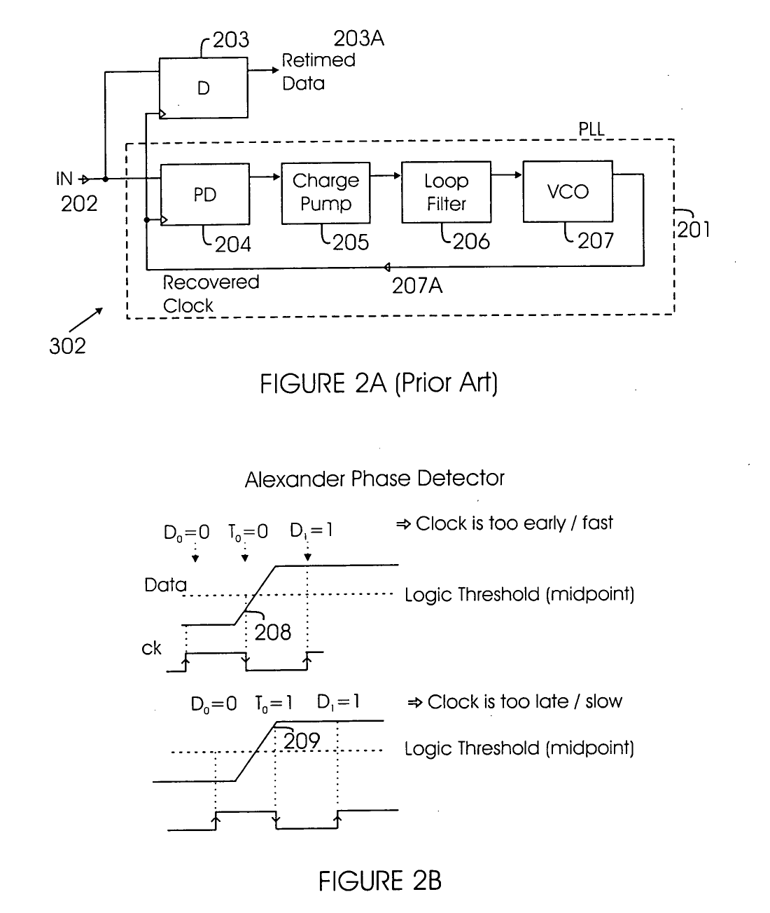

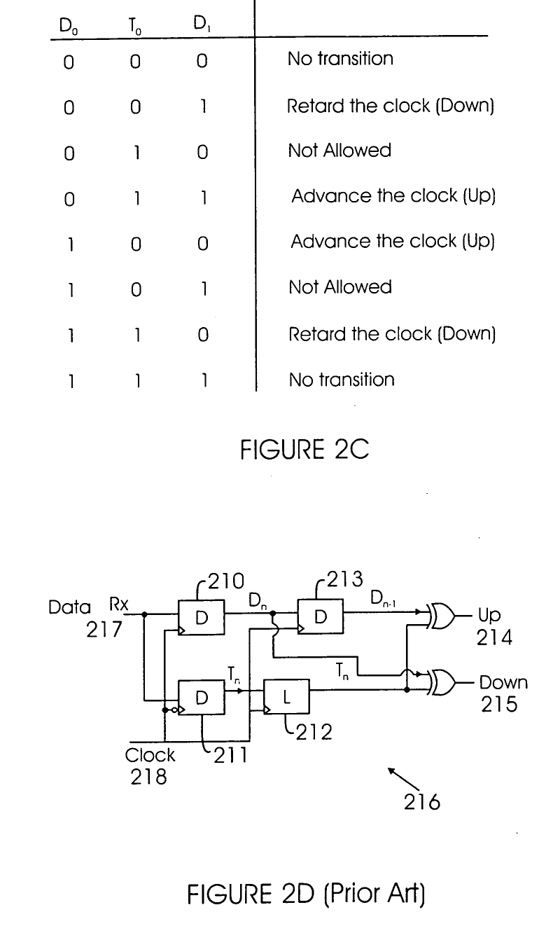

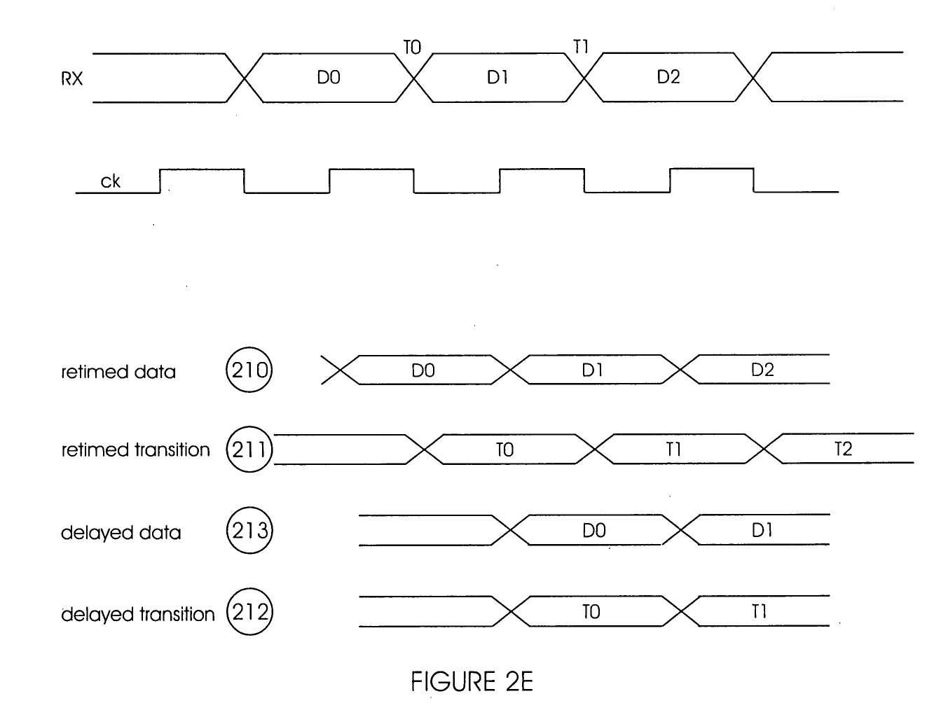

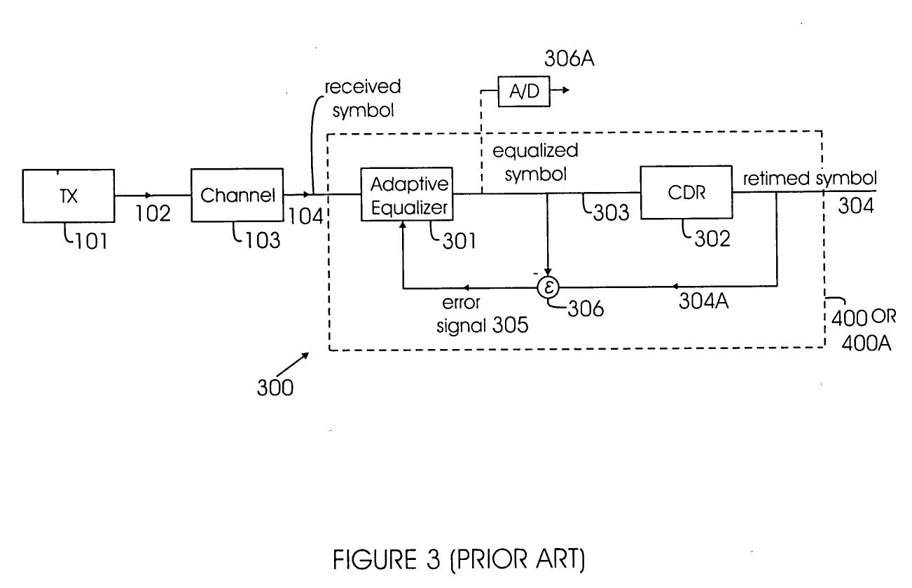

As shown in FIG. 7A, an up signal 705 (similar to 215, FIG. 2) and down (DN) signal 706 (similar to 214, FIG. 2) is received from an Alexander phase detector that has been described above. The present invention saves two samples, for example, D0, T0, D1 and D1, T1, D2 to generate the wide signal 703A and narrow signal 704A via gates 703 and 704, respectively.

D-Flip flop 702 receives the UP signal 705 and D-Flip flop 701 receives the DN signal 706. Both 701 and 702 also receive the clock signal 707. UPn-1 and DNn-1 denote a previous sample and DNn and UPn denote a current sample.

FIG. 7B shown a graphical illustration for generating narrow and wide signals based on two samples. The wide signal 703A and narrow signal 704A are used to update coefficients in the signed error LMS algorithm for transverse filter (FIG. 5) and decision feed back equalizers (FIG. 4).

FIG. 7C shows logic 700 being used with equalizer 106. Logic 700 is used with receiver 105 and together they are shown as 708. It is noteworthy that since the process looks at the width of the symbol instead of the amplitude, a limiting amplifier (not shown) may be used before error detection if a binary modulation scheme, such as Non-Return to Zero (“NRZ”) is used. It is noteworthy that this is different from conventional schemes, which require linear amplification and gain control to provide accurate error estimation. These requirements are difficult to achieve in high-speed systems.

For a transverse filter with a CDR, there are two feedback loops in parallel because the process relies on the recovered clock to adapt the equalizer. One loop is the clock recovery loop of CDR 709 (FIG. 7D) and the other is the adaptation loop of the equalizer coefficients. The time constants for the loops are separated to avoid unwanted interaction and possible oscillation.

FIG. 7D shows an example of using logic 700 in a transverse filter. The equalizer 702B and CDR 709 may be an integral part of receiver 702A. Incoming data 104 is received by equalizer 702B and then sent to phase and error detector 700 that sends a signal to charge pump 205. Charge pump 205 sends a signal to LPF 206 and then to VCO 207. Recovered clock 207A is fed back into phase/error detector 700 that generates a signal 700A, which is sent to multiplier 710B and then sent to an integrator 710 that generates signal 710A, the adjusted equalizer coefficient.

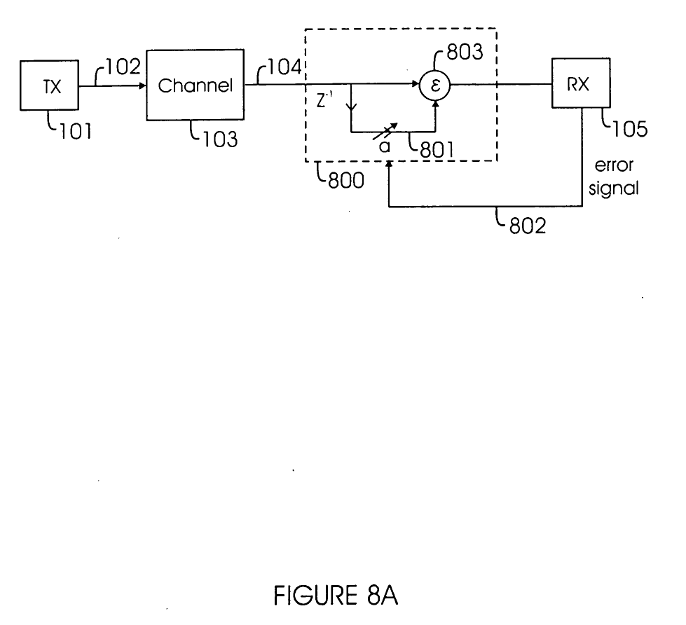

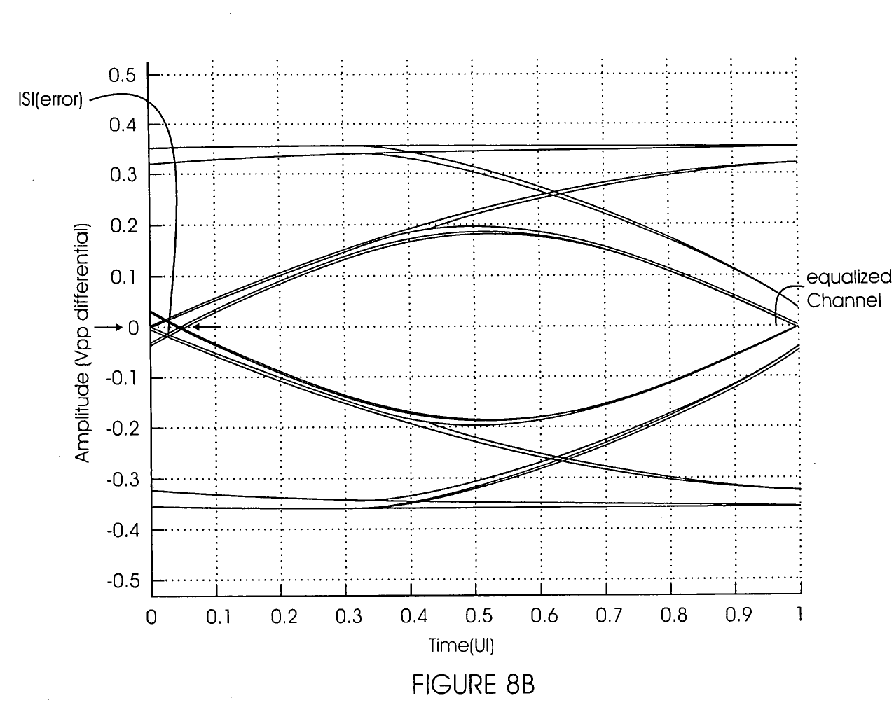

FIG. 8A shows a schematic using an adaptive equalizer 804 with logic 803 that is fed with coefficients 801. Error signal 802 (similar to signal 700A) from receiver 105 is used to adjust coefficients 801. Receiver 105 in this example includes logic 700 that has been described above.

FIG. 8B shows an eye diagram of adaptive equalizer 804 output.

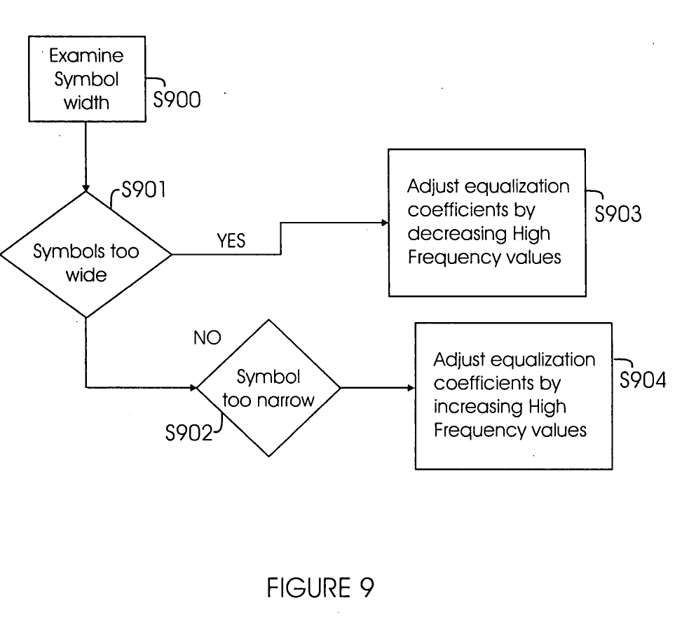

FIG. 9 shows a flow diagram according to one aspect of the present invention.

In step S900, symbols are received and then examined. The width of the symbols is obtained by examining the value of the transition bits when two consecutive data transition occur. This is achieved by examining three consecutive symbols.

In step S901, the process determines if symbols are too wide (as discussed above with respect to FIG. 7A). Successive transition samples are examined to determine whether received symbols are too wide or narrow. If both transition bits are of the same polarity as the central data symbol, the symbol is too wide. Symbols, which are too wide, imply over-equalization, and hence in step S903, equalization co-efficients are adjusted by decreasing high frequency boost values as discussed above.

If the symbols are not wide, then in step S902, the process determines if the symbols are too narrow. This is discussed above with respect to FIG. 7A, where the width of the symbols is obtained by examining the value of the transition bits when two consecutive data transition occur. This is achieved by examining three consecutive symbols. If both transition bits are of opposite polarity of the central bit, the symbol is too narrow.

If the symbol is too narrow, then in step S904, equalization co-efficients are adjusted by increasing high frequency boost values as discussed above.

In one aspect of the present invention, error estimation is performed without using complex components like analog to digital converters.

Although the present invention has been described with reference to specific embodiments, these embodiments are illustrative only and not limiting. Many other applications and embodiments of the present invention will be apparent in light of this disclosure.

1. A circuit for determining whether symbols received in a communication system are too wide or narrow with respect to a clock signal, comprising:
logic for obtaining a symbol width by examining transition bit values for at least three symbols, wherein if the transition bit values are of same polarity as a central data symbol then the symbol width is too wide, or if the transition bits are of opposite polarity, then the symbol is too narrow.

2. The circuit of claim 1, where the logic is a part of a receive segment of the communication system.

3. The circuit of claim 1, where the logic can be used in a decision feedback circuit and/or a transverse filter.

4. The circuit of claim 1, can be used to estimate error in a least mean square algorithm.

5. A method for error estimation in a communication system, comprising:
determining whether received symbols are too wide or narrow with respect to a clock signal by examining transition bit values for at least three symbols, wherein if the transition bit values are of same polarity as a central data symbol then the symbol width is too wide, or if the transition bits are of opposite polarity, then the symbol is too narrow; and
adjusting equalization coefficient values if the symbols are wide or narrow.

6. A system for determining whether symbols received in a communication system are too wide or narrow with respect to a clock signal, comprising:
logic for obtaining a symbol width by examining transition bit values for at least three symbols, wherein if the transition bit values are of same polarity as a central data symbol then the symbol width is too wide, or if the transition bits are of opposite polarity, then the symbol is too narrow.

7. The system of claim 6, where the logic is a part of a receive segment of the communication system.

8. The system of claim 6, where the logic can be used in a decision feedback circuit and/or a transverse filter.

9. The system of claim 6, can be used to estimate error in a least mean square algorithm.
